(19) United States
(12) Patent Application Publication
(10) Pub. No.: US 2023/0265274 A1
(43) Pub. Date: Aug. 24, 2023

(54) FLAME-RETARDANT RESIN COMPOSITION, FLAME-RETARDANT RESIN MOLDED PRODUCT, FLAME-RETARDANT RESIN HOUSING, AND ELECTRONIC DEVICE

(71) Applicant: Konica Minolta, Inc., Tokyo (JP)

(72) Inventors: Kosuke NAKAMURA, Tokyo (JP); Shinichi HAMAGUCHI, Tokyo (JP); Tomoo SAKIMURA, Tokyo (JP)

(73) Assignee: Konica Minolta, Inc., Tokyo (JP)

(21) Appl. No.: 18/159,114

(22) Filed: Jan. 25, 2023

(30) Foreign Application Priority Data
Feb. 18, 2022 (JP) 2022-023403

(51) Int. Cl. C08L 25/06; C08L 55/02; C08L 67/04

(52) U.S. Cl. CPC C08L 25/06; C08L 55/02; C08L 67/04; C08L 2201/02

(57) ABSTRACT

A flame-retardant resin composition includes an acidic polysaccharide and a flame retardant.

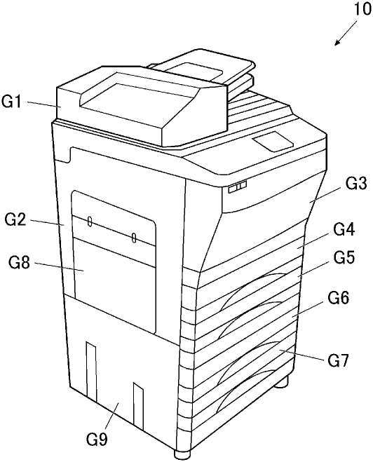

### TECHNICAL FIELD

The present invention relates to a flame-retardant resin composition, a flame-retardant resin molded product, a flame-retardant resin housing, and an electronic device. More specifically, the present invention relates to an excellent flame-retardant resin composition and the like.

### DESCRIPTION OF THE RELATED ART

In recent years, biomass resins synthesized from biodegradable biomass materials have been attracting attention as an alternative to petroleum materials from the viewpoint of the need to reduce the environmental burden. Compared to petroleum-based resins that are synthesized from petroleum as a raw material, the biomass resins are expected to reduce energy consumption during manufacturing and carbon dioxide emissions during final incineration. On the other hand, when biomass resins are used in electronic devices, flame retardancy is required from the viewpoint of safety.

A polysaccharide is added to resins as a known example of a method of imparting flame retardancy to resins. A polysaccharide is a compound having a basic backbone of a cyclic structure containing a large amount of hydroxy groups. The water vapor generated as a result of dehydration and condensation of the heated polysaccharide during burning causes cooling effect due to the large amount of heat absorption, dilution of combustion gases, blocking of oxygen, and so on. In addition, carbonization of the polysaccharide after dehydration results in the formation of a coating (hereinafter referred to as “char” or “carbonized layer”) that has an insulating effect. As a result, a high flame retardant effect can be achieved.

However, when the polysaccharide is added to a resin, the polysaccharide is difficult to be dispersed uniformly in the resin depending on compatibility of the polysaccharide with the resin, and it was difficult to uniformly impart flame retardancy to the entire resin. In addition, the heat generated when the polysaccharide is added to the resin and mixed causes dehydration and condensation of the polysaccharide, resulting in problems such as reduced flame retardancy.

To address such problems, JP2005-162872A discloses a technology related to a resin composition containing a polysaccharide, a flame-retardant additive containing a phosphorus-containing compound, and a hydrolysis inhibitor that inhibits hydrolysis of the polysaccharide. In this technology, a combination of the polysaccharide, the flame-retardant additive, and the hydrolysis inhibitor improves both flame retardancy and storage properties.

JP2010-31230A discloses a technology related to a flame-retardant resin composition containing a phosphorus-containing polysaccharide that is a natural polysaccharide with phosphate esters added to its side chains. Because of the phosphorus-containing polysaccharide, the resin composition according to this technology has low petroleum dependency, high blending ratio of a plant-derived component, and low environmental burden, as well as impact resistance, formability, and flame retardancy.

However, the demand for flame retardancy is increasing still more, and all of the above technologies had room for further improvement.

### SUMMARY OF THE INVENTION

The present invention was made in view of the above problems and circumstances, and an object of the present invention is to provide an excellent flame-retardant resin composition, a flame-retardant resin molded product, a flame-retardant resin housing, and an electronic device.

The inventors of the present invention have examined the cause of the above problems and the like in order to solve the above problems, found that a flame-retardant resin composition having an acidic polysaccharide and a flame retardant has an excellent flame retardancy, and arrived at the present invention.

That is, the above problems related to the present invention are solved by the following means.

To achieve at least one of the above-mentioned objects, a flame-retardant resin composition that reflects an aspect of the present invention includes an acidic polysaccharide and a flame retardant.

A flame-retardant resin molded product that reflects another aspect of the present invention is formed of the flame-retardant resin composition of the present invention.

A flame-retardant resin housing that reflects another aspect of the present invention includes the flame-retardant resin molded product of the present invention.

An electronic device that reflects another aspect of the present invention includes the flame-retardant resin molded product of the present invention.

### BRIEF DESCRIPTION OF THE DRAWINGS

The advantages and features provided by one or more embodiments of the invention will become more fully understood from the detailed description given hereinafter and the appended drawing which is given by way of illustration only, and thus are not intended as a definition of the limits of the present invention, and wherein:

The FIGURE shows a schematic diagram of a large-size photocopier as an application example of the flame-retardant resin molded product of the present invention.

### DETAILED DESCRIPTION

Hereinafter, one or more embodiments of the present invention will be described with reference to the drawings. However, the scope of the invention is not limited to the disclosed embodiments.

Although the mechanism of expressing the effect and action mechanism of the present invention have not been clarified, they are inferred as follows.

In one method of imparting flame retardancy to the resin, water vapor is generated from inside of the resin in response to ignition of the resin and lowers the temperature of the resin, such that the resin stops burning. Specifically, as described above, it is considered that a resin containing a polysaccharide generates water vapor upon the progress of the dehydration-condensation reaction of the polysaccharide, which can lower the temperature of the resin. The polysaccharides specifically described in JP2005-162872A and JP2010-31230A provide some flame retardancy but are not sufficient. Therefore, further improvement has been desired.

The inventors of the present invention have studied and found that flame retardancy can be improved when the polysaccharide includes an acidic polysaccharide, which has a portion that functions as an acid in the molecule.

It is considered, though not certain, that acidic functional groups in most of the acidic polysaccharide easily release protons (H⁺), thereby facilitating the dehydration-condensation reaction with the hydroxy groups in the polysaccharide. Then, the flame retardancy is considered to be improved because the temperature of the resin is lowered by the water vapor generated as a result of the dehydration-condensation reaction and because a carbonized layer is formed by carbonization of the dehydrated polysaccharide and cuts off the supply of oxygen.

The inventors of the present invention have further studied and found that flame retardancy is dramatically improved when the resin further includes a flame retardant, which exhibits a synergistic effect with the acidic polysaccharide. They have also found that, depending on the type of the flame retardant, the resulting resin has excellent mechanical strength and appearance.

The flame-retardant resin composition of the present invention includes an acidic polysaccharide and a flame retardant.

This is a technical feature common to or corresponding to the following embodiments.

In an embodiment of the present invention, from the viewpoint of excellent mechanical strength and appearance in addition to the flame retardancy, the flame retardant is preferably a phosphorus compound.

From the viewpoint of the excellent flame retardancy, the acidic polysaccharide preferably includes at least one of a polysaccharide having an acidic functional group, a derivative of the polysaccharide having the acidic functional group and having a modified moiety that is not in the acidic functional group, a salt of the polysaccharide having the acidic functional group, and a salt of the derivative.

From the viewpoint of the excellent flame retardancy, the total number of acidic functional groups that is optionally neutralized per monosaccharide unit in the acidic polysaccharide is preferably in the range of 0.20 to 1.50.

From the viewpoint of the excellent mechanical strength and appearance in addition to the flame retardancy, the acidic polysaccharide preferably includes the salt that is formed with an ion having two or more valences.

From the viewpoint of the excellent flame retardancy, a total number of the acidic functional group that is optionally neutralized per monosaccharide unit in the acidic polysaccharide is preferably in the range of 0.60 to 1.20.

From the viewpoint of the excellent mechanical strength and appearance in addition to the flame retardancy, a content of the acidic polysaccharide is preferably in the range of 5 to 40% by mass relative to a total mass of the flame-retardant resin composition.

From the viewpoint of the excellent mechanical strength and appearance in addition to the flame retardancy, a content of the flame retardant is preferably in the range of 1 to 20% by mass relative to a total mass of the flame-retardant resin composition.

From the viewpoint of the excellent flame retardancy, the acidic functional group is preferably a carboxy group or a sulfo group.

From the viewpoint of the excellent flame retardancy, the acidic polysaccharide preferably includes at least one of alginic acid, a salt of alginic acid, carrageenan, pectin, xanthan gum, and gellan gum.

From the viewpoint of the excellent mechanical strength and appearance in addition to the flame retardancy, the acidic polysaccharide preferably includes calcium alginate as the salt of alginic acid.

From the viewpoint of the excellent mechanical strength and appearance in addition to the flame retardancy, the phosphorus compound is preferably a phosphate ester.

From the viewpoint of easy handling, the flame-retardant resin composition preferably further includes a thermoplastic resin. From the viewpoint of the excellent mechanical strength and appearance in addition to the flame retardancy, the softening point of the thermoplastic resin is preferably 200° C. or lower, and the thermoplastic resin is particularly preferably a polystyrene-based resin.

The flame-retardant resin molded product of the present invention is formed of the flame-retardant resin composition of the present invention. The flame-retardant resin molded product of the present invention is included by the flame-retardant resin housing of the present invention, and by the electronic device of the present invention.

In the following, detailed explanations of the present invention, components of the present invention, and embodiments and modes for carrying out the present invention will be given. In this application, a range described using “to” means that the numerical values before and after it are included as a lower limit and an upper limit, respectively.

### Summary of Flame-Retardant Resin Composition

The flame-retardant resin composition of the present invention is characterized by the inclusion of an acidic polysaccharide and a flame retardant.

In the present invention, the “flame-retardant resin composition” refers to the following resin composition that has the “flame retardancy.”

The term “flame retardancy” refers to a kind of heat resistance properties, that is, the property of burning slowly but continuing to burn to some extent.

Specifically, a composition having the “flame retardancy” is a composition that meets the acceptance criteria of the UL94 standard defined by Underwriters Laboratories Inc. (UL), to be more specific, a composition that is classified as UL94HB in the UL94 test (Test for Flammability of Plastic Materials for Parts in Devices and Appliances). In addition, a composition having the “flame retardancy” is preferably classified as V-2, more preferably as V-1, and even preferably as V-0 in UL94V.

In this application, the term “burning” refers to an oxidation reaction accompanying generation of light and heat. Burning requires three elements: a burnable material, an oxygen supply source, and an ignition source.

Once the resin (the burnable material) catches fire (ignition source), the following phenomena (a) to (c) are repeated so that the burning continues.

(a) The resin (the burnable material) melts and decomposes due to the high temperature, and a large amount of burnable gas is generated.

(b) Due to the high temperature environment, radicalization of the burnable gas and chemical reactions between the radicalized gas and oxygen in the air (oxygen source) are accelerated, resulting in generation of a lot of light and heat.

(c) The generated heat maintains the high temperature environment, resulting in continuous decomposition of the resin.

Therefore, when the temperature is lowered, the oxygen supply is cutoff, or the burnable gas is removed, it is possible to stop the burning. A resin that is designed to cause any of the above phenomena upon catching fire have flame retardancy.

Examples of a method of providing a resin with the flame retardancy include: lowering of the temperature by generation of water vapor from inside the resin (cooling due to absorption of a large amount of heat by the vapor); cutoff of oxygen supply by generation of a large amount of unburnable gas from inside the resin so that the oxygen concentration is lowered; cutoff of oxygen supply by a barrier layer formed by carbonization of the surface of the resin (corresponding to “char” or “carbonized layer” in the present invention), and the like.

In the present invention, it is assumed that the resin composition includes an acidic polysaccharide so as to cause the above phenomenon and so as to have flame retardancy. It is also assumed that the flame retardancy can be improved when the resin composition further includes a flame retardant.

A resin composition can be formed in an appropriate shape and form to be used as a housing and a component in an electronic device and the like. In addition to the flame retardancy, the resin composition os required to have excellent mechanical strength and appearance, especially when used as a housing.

As for the mechanical strength, it can be effectively improved by the use of a resin with high mechanical strength after curing. However, it is assumed that, from the viewpoint of the flame retardancy, the resin also needs to have excellent compatibility with the acidic polysaccharide and the flame retardant. As for the appearance, it is assumed that difference in physical properties of the materials used in the resin composition (in particular, the physical properties depending on temperature) is one of the causes of unevenness in color in molding. Therefore, it is assumed that materials that are less likely to cause unevenness in color need to be combined.

From such a viewpoint, as a result of selection of appropriate materials, mixing of the materials under appropriate conditions (for example, mixing ratio), and subsequent molding as needed, it is assumed to be possible to provide the resin composition with better mechanical strength and appearance in addition to the flame retardancy.

### Configuration of Flame-Retardant Resin Composition

The flame-retardant resin composition of the present invention is characterized by containing an acetic polysaccharide and a flame retardant.

Components of the flame-retardant resin composition are each described in the following. From the viewpoint of reducing environmental burden, the materials used for the flame-retardant resin composition is preferably biomass materials, but may be materials other than biomass materials.

### 1. Acidic Polysaccharide

The flame-retardant resin composition of the present invention includes an acidic polysaccharide.

The flame-retardant resin composition of the present invention has flame retardancy by having the acidic polysaccharide.

In the present invention, the term “acidic polysaccharide” refers to a polysaccharide having a portion that functions as an acid in its molecule.

The term “polysaccharide” is a general term for a substance made of a large number of monosaccharide molecules dehydrated and condensed by glycosidic bonds. The polysaccharide has one or more types of monosaccharides as its constituent units.

The term “monosaccharide” is a general term for sugars that cannot be hydrolyzed any more. The “monosaccharide” is a chain polyhydroxy compound having an aldehyde group or a ketone group, and usually exists in a cyclic form, forming a hemiacetal structure within the molecule. The monosaccharide is preferably a pentose or hexose, and more preferably a hexose.

The degree of polymerization of the polysaccharide, for example, is preferably in the range of 50 to 20,000, more preferably in the range of 200 to 1,500, and even more preferably in the range of 200 to 1,100.

The weight average molecular weight of the polysaccharide determined by gel permeation chromatography (GPC) based on polystyrene is preferably in the range of 10,000 to 250,000, and more preferably in the range of 20,000 to 80,000.

In addition, the portion that “functions as an acid” means a portion that functions as a receptor (acceptor) that receives a pair of electrons involved in binding (according to Lewis’ definition). The function as an acid also includes the function as a proton (H+) donor (according to Brønsted’s definition).

From the viewpoint of the excellent flame retardancy, the acidic polysaccharide is preferably a polysaccharide having an acidic functional group, a derivative of the polysaccharide having the acidic functional group and having a modified moiety that is not in the acidic functional group, or a salt of the polysaccharide or the derivative. One of these acidic polysaccharides may be used alone, or two or more of them may be used in combination.

Examples of the derivative of the polysaccharide having an acidic functional group and having a modified moiety that is not in the acidic functional group include:
a compound obtained by replacing an atom at a portion other than the acid functional group in the polysaccharide having an acid functional group with a different atom or a substituent;
a compound obtained by bonding a polysaccharide having an acid functional group to another compound or another molecule of the polysaccharide having the acid functional group via a functional group other than the acid functional group (for example, an hydroxy group originally existing in a sugar chain of the polysaccharide); and the like. Specific examples include the cross-linked polysaccharides described below.

Examples of the acidic functional group of the acidic polysaccharide include: a carboxy group (—COOH), a sulfo group (—SO₃H), a thiocarboxy group (—CSOH), a sulfino group (—SO₂H), a sulfeno group (—SOH), a phospho group (—OP(═O)(OH)₂), a phosphono group (—P(═O)(OH)₂), a borono group (—B(OH)₂), and the like. Among these, a carboxy group and a sulfo group are preferred from the viewpoint of the flame retardancy. The acidic functional group may be an acidic functional group having a sulfo group, for example, an acidic functional group in which a sulfo group is bonded to an oxygen atom (—O—SO₃H).

The acidic functional group may react with an ion of an alkali metal including Li, Na, and K, an alkaline earth metal including Mg, Ca, Sr, and Ba, and alkylammonium, so that the acid polysaccharide forms a salt. The alkylammonium ion is represented by “-NR4⁺”, where the four “R”s are each independently a hydrogen atom or an alkyl group having one to three carbon atoms, and at least one of the four “R”s is an alkyl group.

In particular, the salt is preferably formed with an ion having two or more valences. The salt with an ion having two or more valences forms an intramolecular or intermolecular crosslinked structure, resulting in a rigid structure. This dramatically improves heat resistance and prevents deformation of the resin composition during melt kneading and molding, resulting in superior mechanical strength and appearance.

From the viewpoint of the excellent flame retardancy, the total number of the acidic functional groups and salts of the acidic functional groups (i.e., the total number of the acidic functional groups that is optionally neutralized) per monosaccharide unit in the acidic polysaccharide (hereinafter simply referred to as “the number of acidic functional groups”) is preferably in the range of 0.20 to 1.50, more preferably in the range of 0.6 to 1.20, and even more preferably in the range of 0.60 to 1.00.

When the number of acidic functional groups is 0.20 or more, dehydration-condensation reaction can easily occur, and the flame retardancy can be improved. When the number of acidic functional groups is 1.50 or less, the dispersibility of the acidic polysaccharide in the resin composition is further reduced. Therefore, it becomes easy to form a uniform char layer on the surface of the resin composition, and the flame retardancy can be improved.

One of the above acidic polysaccharides may be used alone, or two or more of them may be used in combination. When two or more acidic polysaccharides are used in combination, the number of acidic functional groups of all the acidic polysaccharides is preferably within the range mentioned above. However, the number of acidic functional groups of each of the acidic polysaccharides used in combination does not have to be within the range mentioned above. The acidic polysaccharides used in combination can be selected so that the number of acidic functional groups in the obtained acidic polysaccharides as a whole is within the above range.

In other words, when two or more acidic polysaccharides are used in combination, the number of acidic functional groups of each of the acidic polysaccharides to be combined does not have to be in the range of 0.20 to 1.50. The acidic polysaccharides to be used can be selected such that the number of acidic functional groups for the combined acidic polysaccharides as a whole is in the range of 0.20 to 1.50.

The number of acidic functional groups can be adjusted by appropriate inclusion or removal of the acidic functional groups or salts thereof (hereinafter collectively referred to as “acidic functional groups etc.”).

From the viewpoint of reducing environmental burden, the acidic polysaccharide is preferably a naturally existing acidic polysaccharide. In addition, the acidic functional group may be included in or removed from the naturally existing polysaccharide as appropriate so that the number of acidic functional groups can be adjusted within a preferred range.

Examples of the derivative of the acidic polysaccharide include, for example, a compound obtained by replacing an atom (for example, a hydrogen atom) at a portion other than the acid functional group etc. in the above naturally existing acidic polysaccharide that is optionally functionalized with the acidic functional group etc. with a halogen atom or a substituent such as a hydrocarbon group.

Examples of the derivative of acidic polysaccharide include an ester derivative, an ether derivative, and the like that is obtained as a result of reaction of the hydroxy group originally existing in the sugar chain of the acidic polysaccharide with a compound having a functional group that can react with the hydroxy group. An acidic polysaccharide having a functional group other than a hydroxy group may be also used as the derivative after the functional group is reacted with another compound. The derivative may also be a cross-linked polysaccharide as described below.

Examples of the acidic polysaccharide include pectin, alginic acid, propylene glycol alginate, carboxymethyl cellulose, xanthan gum, arabic gum, karaya gum, psyllium, xylan, arabic acid, tragacanthic acid, khava gum, linseed acid, cellulonic acid, richeninuronic acid, gellan gum, ramuzan gum, welan gum, carrageenan, glycosaminoglycans (for example, hyaluronic acid, chondroitin-4-sulfate, chondroitin-6-sulfate, dermatan sulfate, keratin sulfate, and heparin), and salts thereof. Among these, alginic acid, salts of alginic acid, carrageenan, pectin, xanthan gum, and gellan gum are preferred, and calcium alginate is more preferred.

The number of acidic functional groups can be calculated from a molecular structure formula or measured and calculated by a neutralization titration method.

In the following, the molecular structure formulas for alginic acid and carrageenan and the method for calculating the number of acidic functional groups from the molecular structural formulas are explained.

For example, the molecular structure of alginic acid is shown in Formula (A) below. As shown in Formula (A), alginic acid has a carboxy group (—COOH) as the acidic functional group. From the molecular structure shown in Formula (A), the number of acidic functional groups of alginic acid is calculated to be 1.00.

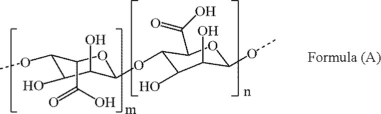

There are three types of carrageenan: k-carrageenan, whose molecular structure is represented by the following Formula (C1); 1-carrageenan, whose molecular structure is represented by the following Formula (C2); and 1-carrageenan, whose molecular structure is represented by the following Formula (C3). As shown in Formulas (C1) to (C3), the acidic functional group of carrageenan is a sulfo group, more specifically, an acidic functional group in which a sulfo group is bonded to an oxygen atom (—O—SO₃H). In Formulas (C1) to (C3), the acidic functional group is described in the ionized state (—OSO₃⁻).

From the molecular structure in Formula (C1), the number of acidic functional groups of k-carrageenan is calculated to be 0.50. From the molecular structure in Formula (C2), the number of acidic functional groups of l-carrageenan is calculated to be 1.00. From the molecular structure in Formula (C3), in which R is typically H (30%) or SO³⁻ (70%), the number of acidic functional groups of λ-carrageenan is calculated to be 1.35.

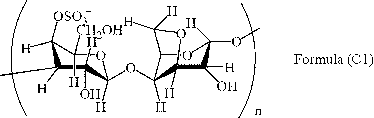

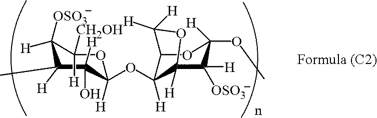

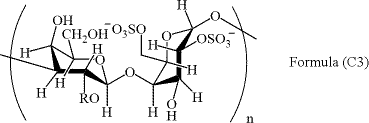

When two or more acidic polysaccharides (for example, m types of acidic polysaccharides) are combined, the number of acidic functional groups can be calculated from the number of acidic functional groups per monosaccharide unit in each acidic polysaccharide and the molar ratio using the following Equations (1) and (2).

$$\begin{matrix}\left(\text{Number of acidic functional groups}\right) = \\ {\text{A}}_{1} ⋅ {\text{R}}_{1} + {\text{A}}_{2} ⋅ {\text{R}}_{2} + {\text{A}}_{3} ⋅ {\text{R}}_{3} + … + {\text{A}}_{\text{m}} ⋅ {\text{R}}_{\text{m}}\end{matrix} \qquad \text{Equation (1):}$$

$${\text{R}}_{\text{k}} = {\text{B}}_{\text{k}} / \left({\text{B}}_{1} + {\text{B}}_{2} {\text{+B}}_{3} + … + {\text{B}}_{\text{m}}\right) \left(\text{k} = 1 , 2 , … \text{m}\right) \qquad \text{Equation (2):}$$

The symbols in the formulas are defined as follows.
Aₖ: Number of acidic functional groups per monosaccharide unit in each type of acidic polysaccharide
Bₖ: Number of moles of monosaccharide units for each type of acidic polysaccharide (a value calculated by dividing the mass of each type of acidic polysaccharide by the molecular weight of the monosaccharide)
Rₖ: Ratio of the number of moles of monosaccharide units for each acidic polysaccharide to the number of moles of monosaccharide units in the entire acidic polysaccharide.

The number of acidic functional groups can also be determined by the following method. In order that the number of acidic functional groups of the acidic polysaccharide contained in the flame-retardant resin composition is determined, first, the acidic polysaccharide is extracted from the flame-retardant resin composition by an appropriate method. The molecular structure of the extracted acidic polysaccharide is determined by thermogravimetric analysis, infrared spectroscopy (IR), and the like.

### Measurement Method of Number of Acidic Functional Groups

Number of acidic functional groups per monosaccharide unit in the acidic polysaccharide can be measured, for example, by a neutralization titration method. In the neutralization titration method, approximately 1 g of the extracted acidic polysaccharide is accurately weighed out and made into a slurry. The slurry is processed with a strongly acidic ion exchange resin. Then, while 0.1 mol/L aqueous sodium hydroxide solution is added thereto, change of pH is observed, and a titration curve is obtained. The number of moles of the sodium hydroxide required from the start of titration to the inflection point of the titration curve is equivalent to the number of moles of acid in the acidic polysaccharide used in the titration. From the obtained number of moles of the acid and the molecular structure, the number of acidic functional groups per monosaccharide unit can be calculated.

In carboxymethyl cellulose, the number of acidic functional groups can be calculated through measurement of a substitution degree of the carboxymethyl groups.

Carboxymethyl cellulose is an acidic polysaccharide that is obtained by functionalization of cellulose with carboxymethyl groups. The number of acidic functional groups in carboxymethyl cellulose can be adjusted within a suitable range by adjusting the manufacturing conditions.

Carboxymethyl cellulose can be manufactured by known manufacturing methods. Specifically, carboxymethyl cellulose can be manufactured by the method described in JP2000-34301A, including a step of alkali cellulose generation through reaction of cellulose with an alkali at a temperature in the range of 20 to 50° C. and a step of carboxymethyl cellulose generation through reaction of the alkali cellulose with a monochloroacetic acid.

Carboxymethyl cellulose can also be manufactured by another method, for example, the method described in JP2012-12553A, including mixing of cellulose, alkaline agent, and monohaloacetic acid or its salt, followed by reacting the mixture under heating in the range of 40 to 90° C.

In any of the methods, the number of acidic functional groups of the resulting carboxymethyl cellulose can be adjusted by adjustment of the amount of monochloroacetic acid or monohaloacetic acid added to the cellulose.

Carboxymethyl cellulose can be represented, for example, by the following Formula (CMC). In the Formula (CMC), R each independently represent H or CH₂COOH. Carboxymethyl cellulose has better flame retardancy when the number of R represented by CH₂COOH per structural formula (CMC) is 0.2 to 1.5 when averaged in the entire molecule, for example.

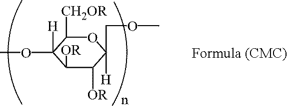

Examples of the acidic polysaccharide that is functionalized with the acidic functional group etc. include, in addition to carboxymethyl cellulose, carboxyalkyl cellulose (functionalized with a carboxyalkyl group including, for example, 2 to 3 carbon atoms), sulfoethylcellulose, hydroxypropyl methyl cellulose acetate succinate, and the like. The acidic polysaccharide of the present invention may also be a polysaccharide other than cellulose (for example, starch, agarose, or guar gum that does not have an acidic functional group, and the like)that is functionalized with the acidic functional group etc.

### Measurement Method of Substitution Degree of Carboxymethyl Group

The number of acidic functional groups in carboxymethyl cellulose can be calculated through measurement of a substitution degree of carboxymethyl groups. The method is described below. The number of acidic functional groups can be calculated with reference to the following method for other acidic polysaccharides as well.

The substitution degree of carboxymethyl groups can be calculated from the measurement of the amount of base, such as sodium hydroxide, required for the neutralization of the carboxymethyl cellulose in the sample. When the carboxymethyl cellulose is in the form of a salt, the salt is converted into carboxymethyl cellulose in advance, and then measurement is performed.

### Conversion Into Carboxymethyl Cellulose

Approximately 2.0 g of the sample is accurately weighed out and placed in a stoppered Erlenmeyer flask (capacity: 300 ml). 100 mL of methanol nitrate (liquid of 100 mL of special grade concentrated nitric acid added to 1000 mL of methanol) is added to the flask. The flask is shaken for 3 hours at room temperature. As a result, the carboxymethyl cellulose salt is converted to carboxymethyl cellulose.

### Measurement of Substitution Degree of Carboxymethyl Cellulose

Approximately 1.5 g of absolutely dry carboxymethyl cellulose is accurately weighed out and placed in a stoppered Erlenmeyer flask (capacity: 300 ml). Then, 15 mL of 80% methanol is added, and the carboxymethyl cellulose is wetted. After that, 100 mL of 0.1 N sodium hydroxide (NaOH) solution is added to the flask. The flask is shaken for 3 hours at room temperature. The remaining excess NaOH is quantified by titration with 0.1 N sulfuric acid (H₂SO₄) using phenolphthalein as an indicator.

The substitution degree of carboxymethyl cellulose is calculated using the following Formulas (i) and (ii).

$$A = \frac{100 \times {f}_{1} - a \times {f}_{2}}{W} \qquad \text{Formula (i):}$$

$$\left(\text{Substitution Degree}\right) = \frac{162 \times A}{10000 - 58 \times A} \qquad \text{Formula (ii):}$$

Symbols and numerical values in Formulas (i) and (ii) each mean the following.
A: amount (mL) of 0.1 N sodium hydroxide solution required to neutralize 1 g of sample (absolutely dry carboxymethyl cellulose)
W: mass (g) of sample
a: amount (mL) of titrant 0.1 N sulfuric acid
f₁: titer factor of 0.1 N sodium hydroxide solution
f₂: titer factor of 0.1 N sulfuric acid
100: amount (mL) of 0.1 N sodium hydroxide solution
162: molecular weight of anhydrous glucose (C₆H₁₀O₅)
58: difference between molecular weight of CH₂COOH (molecular weight: 59) and between of H (molecular weight: 1)

A cross-linked polysaccharide, which is a derivative of the above acidic polysaccharide, can also be used as the acidic polysaccharide.

In the present invention, the “cross-linked polysaccharide” refers to a compound in which two or more polysaccharide molecules are bonded by a cross-linking structure between hydroxy groups of the respective sugar chains. The cross-linked polysaccharide is obtained, for example, by cross-linking of two or more polysaccharide molecules at their respective hydroxy groups using a cross-linking agent. As long as the cross-linking structure using the cross-linking agent is formed between at least two different molecules, a further cross-linking structure may be formed between two hydroxy groups in a single molecule to bond them. The polysaccharide molecules to be cross-linked may be of the same type or of different types.

The cross-linked polysaccharide used in the present invention is a cross-linked acidic polysaccharide, and the above-described acidic polysaccharides can be used without limitation as the acidic polysaccharides constituting the cross-linked polysaccharides. The acidic polysaccharide used in the manufacture (synthesis) of the cross-linked polysaccharide is preferably at least one of the following: alginic acid, alginate, carrageenan, pectin, xanthan gum, and gellan gum. These may be used alone or in combination.

Examples of the cross-linking agent used in obtaining the cross-linked polysaccharide from the acidic polysaccharide include a compound having two or more functional groups that reacts with hydroxy groups. Such functional groups include, for example, epoxy groups, chloro groups, silyl groups, isocyanate groups, acid anhydrides, and the like. Specific examples of the cross-linking agent include epichlorohydrin, hexamethylene diisocyanate, tetraethyl silicate, and the like. Among these, epichlorohydrin is preferred.

Cross-linking of the acidic polysaccharide using epichlorohydrin can be performed, for example, by the reactions shown in Formula (I-1) and Formula (I-2) below. In Formula (I-1) and Formula (I-2), “*” indicates the moiety bonding to a sugar skeleton of the acidic polysaccharide.

In the reaction of Formula (I-1) that is performed under alkaline conditions, an epoxy ring of epichlorohydrin opens and reacts with an OH group of a polysaccharide molecule, and an intermediate (P) is obtained. Further, in the reaction of Formula (I-2), the terminal chloro group derived from epichlorohydrin in the intermediate (P) reacts with an OH group of another polysaccharide molecule, and the two polysaccharide molecules are cross-linked with a linking group (—CH₂—CH(OH)—CH₂—).

In the above, the reactions shown in Formula (I-1) and Formula (I-2) are described as reactions between molecules. However, they also occur within a single molecule as well as between molecules. A molecular terminal (—CH₂—CH(OH)—CH₂—C1) as the in intermediate (P) may also remain in the final reactant.

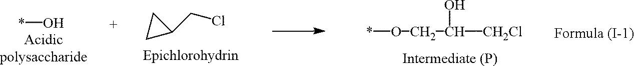

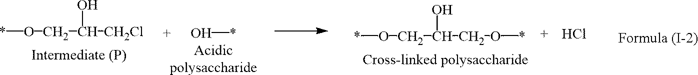

The degree of cross-linking in the cross-linked polysaccharide can be adjusted by the amount of the cross-linking agent added to the acidic polysaccharide. The degree of cross-linking in the cross-linked polysaccharide is preferably adjusted such that the weight average molecular weight of the resulting cross-linked polysaccharide is within the preferred range of the weight average molecular weight of the acidic polysaccharide described above.

The number of acidic functional groups of the obtained cross-linked polysaccharide is theoretically the same as the number of acidic functional groups of the acidic polysaccharide used as the raw material. However, due to reaction of some of the acidic functional groups during production (synthesis), the number of acidic functional groups of the obtained cross-linked polysaccharide is usually less than the number of acidic functional groups of the acidic polysaccharide used as the raw material. Therefore, when the cross-linked polysaccharide is synthesized and used in the present invention, the number of acidic functional groups of the resulting cross-linked polysaccharide is preferably calculated based on measurement using the neutralization titration method.

From the viewpoint of the excellent mechanical strength and appearance in addition to the flame retardancy, the content of acidic polysaccharide is preferably in the range of 5 to 40% by mass relative to the total mass of the flame-retardant resin composition, and more preferably in the range of 20 to 30% by mass.

### 2. Flame Retardant

The flame-retardant resin composition of the present invention includes a flame retardant.

The flame retardancy of the flame-retardant resin composition of the present invention can be further improved due to the inclusion of the flame-retardant.

In the present invention, the “flame retardant” refers to a substance that can provide flame retardancy when contained in a resin. In other words, even when contained in the resin alone without being combined with the acidic polysaccharide described above, the flame retardant can provide the resin with flame retardancy such that the resin is classified as UL94HB in the UL94 test and meets the acceptance criteria of the UL94 test.

In the present invention, the combination of the acidic polysaccharide described above and the flame retardant dramatically improves the flame retardancy. Depending on the type of flame retardant, it is also possible to provide the improved mechanical strength and appearance. Any compound that is commonly used as a flame retardant can be used as the flame retardant of the present invention.

Examples of the flame retardant include a phosphorus compound, red phosphorus, a bromine compound, a chlorine compound, an antimony compound, a boron compound, a nitrogen compound, a metal hydroxide, a silicone compound, a polysaccharide that do not constitute the acidic polysaccharide of the present invention, and the like. These may be used alone or in combination of two or more types.

Among the above examples, phosphorus compounds are preferred from the viewpoint of excellent mechanical strength and appearance in addition to flame retardancy.

From the viewpoint of the excellent mechanical strength and appearance in addition to the flame retardancy, the content of the flame retardant is preferably in the range of 1 to 20% by mass, more preferably in the range of 2 to 16% by mass, and even more preferably in the range of 3 to 12% by mass, relative to the total mass of the flame-retardant resin composition.

### 2.1. Phosphorus Compound

From the viewpoint of the excellent mechanical strength and appearance in addition to the flame retardancy, the flame retardant is preferably a phosphorus compound. Phosphorus compounds can be handled more easily than red phosphorus.

The expression mechanism or action mechanism when the phosphorus compound is used as the flame retardant is not clear, but is inferred as follows.

When the flame-retardant resin composition of the present invention including the phosphorus compound is burned, the phosphorus contained in the phosphorus compound combines with oxygen and water in the air so that a phosphoric acid is generated and then mixed with a carbonized polysaccharide to form a char. Also, since water is consumed in generation of the phosphoric acid, the dehydration-condensation reaction of acidic polysaccharide is accelerated. Furthermore, since both phosphoric acid and acidic polysaccharide easily form hydrogen bonds and have high affinity, the phosphoric acid and the acidic polysaccharide are relatively close to each other in the resin composition. As a result, the synergistic effect of the phosphoric acid and acidic polysaccharide is considered to be easily realized in the resin composition.

Examples of the phosphorus compound include phosphate esters, phosphates, and the like.

Examples of the phosphate ester include: aromatic phosphate esters such as triphenyl phosphate, credyldiphenyl phosphate, tricresyl phosphate, tri-xylenyl phosphate, tris(t-butylated phenyl)phosphate, tris(i-propylated phenyl)phosphate, and 2-ethylhexyl diphenyl phosphate; aromatic condensed phosphate esters such as 1,3-phenylene bis(diphenyl phosphate), 1,3-phenylene bis(dixylenyl)phosphate, resorcinol bis(diphenyl)phosphate, and bisphenol A bis(diphenyl phosphate); halogen-containing phosphate esters such as tris(dichloropropyl)phosphate, tris(β-chloropropyl)phosphate, and tris(chloroethyl)phosphate; and halogen-containing condensed phosphate esters such as 2,2-bis(chloromethyl)trimethylene bis(bis(2-chloroethyl)phosphate) and polyoxyalkylene bis(dichloroalkyl)phosphate.

Examples of a monophosphate as the phosphate include, for example, ammonium salts such as ammonium phosphate, ammonium dihydrogen phosphate, and diammonium hydrogen phosphate; sodium salts such as monosodium phosphate, disodium phosphate, trisodium phosphate, monosodium phosphite, disodium phosphite, and sodium hypophosphite; potassium salts such as monopotassium phosphate, dipotassium phosphate, tripotassium phosphate, monopotassium phosphite, dipotassium phosphite, potassium hypophosphite; lithium salts such as monolithium phosphate, dilithium phosphate, trilithium phosphate, monolithium phosphite, dilithium phosphite, and lithium hypophosphite; barium salts such as barium dihydrogen phosphate, barium hydrogen phosphate, tribarium phosphate, and barium hypophosphite; magnesium salts such as magnesium monohydrogen phosphate, magnesium hydrogen phosphate, trimagnesium phosphate, and magnesium hypophosphite; calcium salts such as calcium dihydrogen phosphate, calcium hydrogen phosphate, tricalcium phosphate, and calcium hypophosphite; zinc salts such as zinc phosphate, zinc phosphite, and zinc hypophosphite; and aluminum salts such as aluminum phosphate monobasic, aluminum phosphate dibasic, aluminium phosphate tribasic, aluminium phosphite, and aluminium hypophosphite.

The phosphate preferably has a large molecular weight and is more preferably a polyphosphate.

Examples of the polyphosphate include, for example, ammonium polyphosphate, piperazine polyphosphate, melamine polyphosphate, ammonium amide polyphosphate, and aluminum polyphosphate.

The content of phosphorus compound relative to the total mass of the flame-retardant resin composition is preferably in the range of 1 to 20% by mass, more preferably in the range of 1 to 15% by mass, and even more preferably in the range of 3 to 15% by mass.

### 2.2. Red Phosphorus

Red phosphorus may be used alone, or may be used in combination with a resin, a metal hydroxide, a metal oxide, or the like as a coating or mixture.

Examples of the resin used as a coating or mixture of red phosphorus are not limited in particular, and include a heat-curable resin such as a phenolic resin, an epoxy resin, an unsaturated polyester resin, a melamine resin, an urea resin, an aniline resins, and a silicone resin.

From the viewpoint of the flame retardancy, red phosphorus is preferably coated or mixed with a metal hydroxide. The metal oxide that can be used is the same as those used as the flame retardant, which will be described later.

### 2.3. Bromine Compound

A bromine compound is not particularly limited as long as is contains bromine in its molecular structure and is solid at room temperature and under normal pressure. Examples of the bromine compound include an aromatic compound containing a brominated aromatic ring, but may also be hexabromocyclododecane and the like, which is a not the aromatic compound containing a brominated aromatic ring.

Examples of the aromatic compound containing a brominated aromatic ring include a bromine compound monomer such as hexabromobenzene, pentabromotoluene, hexabromobiphenyl, decabromobiphenyl, decabromodiphenyl ether, octabromodiphenyl ether, hexabromodiphenyl ether, bis(pentabromophenoxy)ethane, ethylenebis(pentabromophenyl), ethylenebis(tetrabromophthalimide), and tetrabromobisphenol A.

The aromatic compound containing a brominated aromatic ring may be a bromine compound polymer. Specific examples of the bromine compound polymer include: a polycarbonate oligomer manufactured from brominated bisphenol A as a raw material; a brominated polycarbonate such as a copolymer of the polycarbonate oligomer and bisphenol A; a diepoxy compound manufactured by the reaction of brominated bisphenol A and epichlorohydrin; and the like.

Examples of the bromine compound further include: a brominated epoxy compound such as a monoepoxy compound obtained by reaction of brominated phenol with epichlorohydrin; poly(brominated benzyl acrylate); brominated polyphenylene ether; a condensation product of brominated phenol of brominated bisphenol A with cyanuric chloride; a brominated polystyrene such as brominated (polystyrene), poly (brominated styrene), and cross-linked brominated polystyrene; and cross-linked or non-cross-linked brominated poly(-methylstyrene).

### 2.4. Chlorine Compound

Examples of the chlorine compound include polychlorinated naphthalenes and chlorendic acid.

### 2.5 Antimony Compound

Examples of the antimony compound include an antimony oxide, an antimonate, a pyroantimonate, and the like.

Examples of the antimony oxide includes, for example, antimony trioxide, antimony pentoxide, and the like.

Examples of the antimonate include, for example, sodium antimonate, potassium antimonate, and the like.

Examples of the pyroantimonate include, for example, sodium pyroantimonate, potassium pyroantimonate, and the like.

### 2.6. Boron Compound

Examples of the boron compound include borax, a boron oxide, a boric acid, a borate, and the like.

Examples of the boron oxide include diboron trioxide, boron trioxide, diboron dioxide, tetraboron trioxide, and tetraboron pentoxide.

Examples of the borate include a borate of an alkali metal, an alkaline earth metal, an element of Groups 4, 12, or 13 of the periodic table, and ammonium. Examples of the borate include: an alkali metal borate such as lithium borate, sodium borate, potassium borate, and cesium borate; an alkaline earth metal borate such as magnesium borate, calcium borate, and barium borate; zirconium borate; zinc borate; aluminum borate; and ammonium borate.

### 2.7. Nitrogen Compound

Examples of the nitrogen compound include an aliphatic amine compound, an aromatic amine compound, a nitrogen-containing heterocyclic compound, a cyanide compound, an aliphatic amide compound, an aromatic amide compound, urea, and thiourea.

Examples of the aliphatic amine compound include ethylamine, butylamine, diethylamine, ethylenediamine, butylenediamine, triethylenetetetramine, 1,2-diaminocyclohexane, 1,2-diaminocyclooctane, and the like.

Examples of the aromatic amine compound include aniline, phenylenediamine, and the like.

Examples of the nitrogen-containing heterocyclic compound include uric acid, adenine, guanine, 2,6-diaminopurine, 2,4,6-triaminopyridine, triazine compounds, and the like.

The triazine compound is a compound having a triazine skeleton, such as triazine, melamine, benzoguanamine, methylguanamine, cyanuric acid, melamine cyanurate, melamine isocyanurate, trimethyltriazine, triphenyltriazine, amelin, amelide, thiocyanurate, diaminomercaptotriazine, diaminomethyltriazine, diaminophenyltriazine, diaminoisopropoxy triazine, and melamine polyphosphate. Among them, melamine cyanurate, melamine isocyanurate, and melamine polyphosphate are preferred.

Examples of the cyanide compound include dicyandiamide.

Examples of aliphatic and aromatic amide compound include N,N-dimethylacetamide and N,N-diphenylacetamide.

### 2.8 Metal Hydroxide

Examples of the metal hydroxide include aluminum hydroxide, magnesium hydroxide, calcium hydroxide, iron hydroxide, nickel hydroxide, zirconium hydroxide, titanium hydroxide, zinc hydroxide, copper hydroxide, vanadium hydroxide, and tin hydroxide.

The metal hydroxide is preferably in the form of particles. The particles may be in any shape with no particular limitations, and is in the form of spheres, spindles, plates, scales, needles, fibers, and the like, for example. The average primary particle diameter of the metal hydroxide particles is preferably in the range of 10 nm to 100 µm, more preferably in the range of 10 to 100 nm. The average primary particle diameter of the metal hydroxide particles is, for example, the volume-based median diameter (D50). The volume-based median diameter can be measured, for example, by laser diffraction and scattering method using a particle size distribution analyzer (LA-960S2, manufactured by HORIB A, Ltd.).

The surface of the metal hydroxide particles may be modified with a surface modifier if necessary. Examples of the surface modifier include: an alkylsilazanes compound such as hexamethyldisilazane (HMDS); an alkylalkoxysilane such as dimethyldimethoxysilane, dimethyldiethoxysilane, trimethylmethoxysilane, methyltrimethoxysilane, and butyltrimethoxysilane; a chlorosilane compound such as dimethyldichlorosilane and trimethylchlorosilane; silicone oil, a silicone varnish, and various fatty acids. These surface modifiers may be used alone or in combination of two or more types.

The content of metal hydroxide relative to the total mass of the flame-retardant resin composition is preferably in the range of 5 to 20% by mass, and more preferably in the range of 5 to 10% by mass. When the content is within the above range, the resulting molded product can have both excellent mechanical strength and appearance in addition to flame retardancy.

### 2.9. Silicone Compound

Examples of the silicone compound include a silicone compound having a (poly) organosiloxane structure. In particular, a silicone compounds having a modified (poly) organosiloxane structure with substituents such as epoxy groups, hydroxy groups, carboxy groups, amino groups, and ether groups at the molecular ends or on the main chain is preferred.

The silicone compound may be silica particles coated with modified (poly) organosiloxane. The silica particles coated with modified (poly) organosiloxane preferably have a volume average particle diameter in the range of 5 to 250 µm and a bulk density in the range of 0.1 to 0.7.

Examples of commercially available silica particles coated with modified (poly)organosiloxane that can be used include “Si Powder DC4-7051”, “7081”, “7105”, “DC1-9641” (manufactured by Toray Dow Corning Silicone Co., Ltd.)

### 3. Resin

The flame-retardant resin composition of the present invention includes a resin.

The resin can be of any type, including a thermoplastic resin, a heat-curable resin, a light-curable resin, and a heat- and light-curable resin. Among these, from the viewpoint of easy handling, the resin is preferably a thermoplastic resin.

From the viewpoint of reducing burden on the environment, the resin of the present invention is preferably a biomass resin. However, the present invention can also be applied to resins other than biomass resins. A biomass resin and a resin other than a biomass resin may be used in combination.

The content of the resin is preferably in the range of 30 to 95% by mass, more preferably in the range of 40 to 90% by mass, and even more preferably in the range of 50 to 80% by mass, relative to the total mass of the flame-retardant resin composition.

In the present invention, the “content of resin” refers to the mass of the flame-retardant resin composition excluding the acidic polysaccharide, the flame retardant, and various other optionally included additives.

### 3.1. Thermoplastic Resin

From the viewpoint of easy handling, the resin of the present invention is preferably a thermoplastic resin.

The type of the thermoplastic resin is not particularly limited. However, from the viewpoint of inhibiting the decomposition of acidic polysaccharide, and achieving excellent mechanical strength and appearance in addition to flame retardancy, the softening point of the thermoplastic resin is preferably 200° C. or lower.

Examples of thermoplastic resin include: a polystyrene-based resin, a polycarbonate resin, an aromatic polyester resin, a polyphenylene sulfite resin, a polyolefin-based resin, a polyamide-imide resin, a polyetheretherketone resin, a polyethersulfone resin, a polyimide resin, a polyvinyl chloride-based resin, a polyamide resin, a polyacetal-based resin, an acrylic resin, a polystyrene-based thermoplastic elastomer, a polyolefin-based thermoplastic elastomer, a polyurethane-based thermoplastic elastomer, a 1,2-polybutadiene-based thermoplastic elastomer, an ethylene-vinyl acetate copolymerized thermoplastic elastomer, a fluoro-rubber-based thermoplastic elastomer, and a chlorinated polyethylene-based thermoplastic elastomer.

The thermoplastic resin may be a thermoplastic biomass resin. Examples of the thermoplastic biomass resin include an aliphatic polyester, a polyamino acid, polyvinyl alcohol, a polyalkylene glycol, and a copolymer including these.

These thermoplastic resins may be used alone or in combination of two or more types.

Examples of polystyrene-based resins include polystyrene resin, syndiotactic polystyrene resin, acrylonitrile-styrene copolymer (AS resin), and acrylonitrile-butadiene-styrene copolymer (ABS resin).

Examples of aromatic polyester resin include an aromatic polyester having a structure in which an aromatic dicarboxylic acid or its ester derivative component is linked to a diol component such as an aliphatic diol or alicyclic diol through an esterification reaction. Specific examples include, as well as polyethylene terephthalate, polypropylene terephthalate, polybutylene terephthalate, polyethylene naphthalate, polybutylene naphthalate, polyethylene-1,2-bis(phenoxy)ethane-4,4′-dicarboxylate, and the like, copolymerized polyesters such as polyethylene isophthalate/terephthalate, polybutylene terephthalate/isophthalate, and polybutylene terephthalate/decanedicarboxylate.

Examples of aliphatic polyester include a polyoxy acid that is a copolymer of oxyacid and a polycondensate of an aliphatic diol and an aliphatic dicarboxylic acid. Examples of the polyoxy acids include polylactic acid such as poly-L-lactic acid (PLLA), poly-D-lactic acid (PDLA), random copolymers of L-lactic acid and D-lactic acid, and a stereocomplex of L-lactic acid and D-lactic acid, polycaprolactone, polyhydroxybutyric acid, polyhydroxyvaleric acid, and the like. Examples of the polycondensates of aliphatic diols and aliphatic dicarboxylic acids include polyethylene succinate, polybutylene succinate (PBS), polybutylene adipate, and the like.

From the viewpoint of reducing burden on the environment, a thermoplastic biomass resin is preferably used. The thermoplastic biomass resin may be combined with a resin other than the thermoplastic biomass resin and used as a thermoplastic resin that has the advantages of both resins.

From the viewpoint of mechanical strength and easy handling, the thermoplastic resin is preferably a resin having an aromatic ring, such as a polystyrene-based resin, a polycarbonate resin, or an aromatic polyester resin.

Examples of commercially available thermoplastic resins include “Panlite (registered trademark)” (a polycarbonate resin, manufactured by Teijin Chemicals Ltd.), “DURANEX (registered trademark)” (polybutylene terephthalate, manufactured by Polyplastics Co., Ltd.), “KURAPET (registered trademark)” (polybutylene terephthalate, manufactured by KURARAY CO., LTD.), “Amilan (registered trademark)” (polyamide resin, manufactured by TORAY INDUSTRIES, INC.), “LACEA (registered trademark)” (polylactic acid resin, manufactured by Mitsui Chemicals, Inc.), and “TERRAMAC (registered trademark)” (polylactic acid resin, manufactured by UNITIKA LTD.).

### 3.1.1. Polystyrene-Based Resin

From the viewpoint of the mechanical strength and easy handling, the thermoplastic resin of the present invention is preferably a polystyrene-based resin.

When a phosphorus compound is used as the flame retardant, a polystyrene-based resin used as the thermoplastic resin of the present invention can reduce bleeding (leaching out) of the phosphorus compound.

In the present invention, a “polystyrene-based resin” refers to a polymer containing at least a styrene-based monomer as a monomer component. Here, the “styrene-based monomer” refers to a monomer including a styrene skeleton.

The styrene-based monomer is not particularly limited as long as it is a monomer having a styrene skeleton in its structure. Examples of the styrene-based monomer include: styrene; a nuclear alkyl-substituted styrene such as o-methylstyrene, m-methylstyrene, p-methylstyrene, 2,4-dimethylstyrene, ethylstyrene, and p-tert butylstyrene; and an aromatic vinyl compound monomer including α-alkyl substituted styrene such as α-methylstyrene, α-methyl-p-methylstyrene. Among these, styrene is preferred.

The polystyrene-based resin may be a homopolymer of styrene monomers or a copolymer of a styrene monomer and another monomer. Monomer components that can be copolymerized with the styrene monomer include: unsaturated carboxylic acid alkyl ester monomers including alkyl methacrylate monomers such as methyl methacrylate, cyclohexyl methacrylate, methylphenyl methacrylate, and isopropyl methacrylate, and alkyl acrylate monomers such as methyl acrylate, ethyl acrylate, butyl acrylate, 2-ethylhexyl acrylate, and cyclohexyl acrylate; unsaturated carboxylic acid monomers such as methacrylic acid, acrylic acid, itaconic acid, maleic acid, fumaric acid, and silicic acid; unsaturated dicarboxylic anhydride monomers such as anhydrides of maleic acid, itaconic acid, ethyl maleic acid, methyl itaconic acid, and chloromaleic acid; unsaturated nitrile monomers such as acrylonitrile and methacrylonitrile; and conjugated diene monomers such as 1,3-butadiene, 2-methyl-1,3-butadiene (isoprene), 2,3-dimethyl-1,3 butadiene, 1,3-pentadiene, and 1,3-hexadiene. Two or more of these may be copolymerized. The ratio of such copolymerized monomer(s) relative to the total mass of styrene based monomers is preferably 50% by mass or less, more preferably 40% by mass or less, and even more preferably 30% by mass or less.

From the viewpoint of heat resistance and the like, the polystyrene based resin is preferably polystyrene resin, syndiotactic polystyrene resin, acrylonitrile-styrene copolymer (AS resin), acrylonitrile-butadiene-styrene copolymer (ABS resin), styrene-methacrylic acid copolymer, styrene-maleic anhydride copolymer, and the like.

From the viewpoint of the mechanical strength and heat resistance, in the acrylonitrile-butadiene-styrene copolymer (ABS resin), the ratio of the copolymerized acrylonitrile to the total mass of the ABS resin is preferably in the range of 1 to 40% by mass, more preferably in the range of 1 to 30% by mass, and even more preferably in the range of 1 to 25% by mass.

In the styrene-methacrylic acid copolymer, the ratio of the copolymerized methacrylic acid to the total mass of the styrene-methacrylic acid copolymer is preferably 0.1% by mass or more from the viewpoint of heat resistance, and is preferably 50% by mass or less from the viewpoint of imparting transparency. When both heat resistance and transparency are desired, the ratio of the copolymerized methacrylic acid to the total mass of the styrene-methacrylic acid copolymer is preferably in the range of 0.1 to 40% by mass, and more preferably in the range of 0.1 to 30% by mass.

In the styrene-maleic anhydride copolymer, the ratio of the copolymerized methacrylic acid to the total mass of the styrene-maleic anhydride copolymer is preferably 0.1% by mass or more from the viewpoint of heat resistance, and is preferably 50% by mass or less from the viewpoint of imparting transparency. When both heat resistance and transparency are desired, the ratio of the copolymerized methacrylic acid to the total mass of the styrene-maleic anhydride copolymer is preferably in the range of 0.1 to 40% by mass, and more preferably in the range of 0.1 to 30% by mass.

Commercially available polystyrene-based resins include “CLEAREN (registered trademark)” (manufactured by Denka Company Limited), “ASAFLEX (registered trademark)” (manufactured by Asahi Kasei Corp.), “Styrolux (registered trademark)” (manufactured by INEOS Styrolution), and “PSJ (registered trademark) polystyrene” (manufactured by PS Japan Corporation).

The content of the polystyrene-based resin relative to the total mass of the thermoplastic resin is preferably 50% by mass or more, more preferably 60% by mass or more, and even more preferably 80% by mass or more. In the flame-retardant resin composition of the present invention, the thermoplastic resin is particularly preferably composed of polystyrene-based resin only.

### 3.2. Heat-Curable Resin

The resin of the present invention may be a heat-curable resin.

The type of the heat-curable resin is not particularly limited. However, from the viewpoint of inhibiting the decomposition of acidic polysaccharide and achieving the excellent mechanical strength and appearance in addition to the flame retardancy, the curing point of the heat-curable resin is preferably 200° C. or lower.

The heat-curable resin can be any resin having one or more functional groups in one molecule that can be used for cross-linking reaction when heated. Examples of such functional groups include hydroxy groups, phenolic hydroxy groups, methoxymethyl groups, carboxy groups, amino groups, epoxy groups, oxetanyl groups, oxazoline groups, oxazine groups, aziridine groups, thiol groups, isocyanate groups, blocked isocyanate groups, blocked carboxy groups, silanol groups, and the like.

Examples of the heat-curable resin include acrylic resin, maleate resin, polybutadiene based resin, polyester resin, polyurethane resin, epoxy resin, oxetane resin, phenoxy resin, polyimide resin, polyamide resin, phenolic resin, alkyd resin, amino resin, polylactic acid resin, oxazoline resin, benzoxazine resin, silicone resin, fluorine resin, and the like.

In addition to the above-mentioned examples, the heat-curable resin of the present invention may also contain a so-called “curing agent” such as a resin or a low molecular weight compound that reacts with the above-mentioned functional groups and forms chemical cross-links, as needed.

Commercially available acrylic resins include “ACRYDIC (registered trademark)” (acrylic resin including a hydroxy group or carboxy group, manufactured by DIC CORPORATION), “8UA (registered trademark)” (Urethane modified acrylic polymer including a hydroxy group, manufactured by Taisei Fine Chemical Co., Ltd.), and the like.

Commercially available maleate resins include “MALKYD (registered trademark)” (maleic resin, manufactured by Arakawa Chemical Industries, Ltd.), “ARASTAR (registered trademark)” (styrene-maleic resin, manufactured by Arakawa Chemical Industries, Ltd.), “ISOBAM (registered trademark)” (copolymer of isobutylene and maleic anhydride, manufactured by KURARAY CO., LTD), and the like.

Commercially available polydiene resins include “Poly bd (registered trademark)” (hydroxyl Terminated Poly butadiene, manufactured by Idemitsu Kosan Co., Ltd.), “Poly ip (registered trademark)” (hydroxyl terminated Poly isoprene, manufactured by Idemitsu Kosan Co., Ltd.), “EPOL (registered trademark)” (hydroxyl terminated liquid Poly olefin, manufactured by Idemitsu Kosan Co., Ltd.), “NISSO-PB (registered trademark)” (polybutadiene resin, manufactured by NIPPON SODA CO., LTD.), and the like.

Commercially available polyester resins include “elitel (registered trademark)” (hydroxy-terminated or carboxy-terminated polyester, manufactured by UNITIKA LTD.), “vylon (registered trademark)” (hydroxy-terminated or carboxy-terminated polyester, manufactured by TOYOBO CO., LTD.), “Nichigo-POLYESTER (registered trademark)” (manufactured by Mitsubishi Chemical Corporation), and the like.

Commercially available polyurethane resins include “vylon (registered trademark) UR” (hydroxy-terminated or carboxy-terminated polyurethane, manufactured by TOYOBO CO., LTD.) and the like.

Commercially available epoxy resins include “Epotohto (registered trademark)” (manufactured by NIPPON STEEL Epoxy Manufacturing Co., Ltd.), “jER (registered trademark)” (manufactured by Mitsubishi Chemical Corporation), “EPICLON (registered trademark)” (manufactured by DIC CORPORATION), and the like.

Commercially available oxetane resins include “ARON OXETANE” (manufactured by TOAGOSEI CO., LTD.), “ETERNACOLL (registered trademark)” (manufactured by UBE Corporation), and the like.

Commercially available phenoxy resins include “jER (registered trademark) 1256,” “4275,” and “4250” (manufactured by Mitsubishi Chemical Corporation), “PKHH” and “PKHB” (manufactured by TOMOE Engineering Co., Ltd.)

Commercially available polyimide resins include “LUXYDIR (registered trademark) (former trade name: UNIDIC) V-8000” (Branched polyimide resin containing carboxy group, manufactured by DIC CORPORATION) and the like.

Commercially available polyamide resins include “NEWMIDE” (manufactured by Harima Chemicals Group, Inc.), “Trezine (registered trademark)” (manufactured by Nagase ChemteX Corporation), and the like.

Commercially available phenolic resins include “HARIPHENOL” (rosin-modified phenolic resin and varnish, manufactured by Harima Chemicals Group, Inc.), “FUDOWLITE (registered trademark)” (manufactured by Fudow Co., Ltd.), “NIKANOL (registered trademark)” (xylene resin, manufactured by Fudow Co., Ltd.), “Maruka Lyncur (trade name)” (poly(paravinyl phenol) resin, manufactured by MARUZEN CHEMICAL TRADING CO., LTD.), “PHENOLITE (registered trademark)” (novolac phenol resin, manufactured by DIC CORPORATION), and the like.

Commercially available alkyd resins include “ALUKIDIR (registered trademark) (former trade name: BECKOSOL)” (manufactured by DIC CORPORATION), “HARIPHTHAL (registered trademark)” (manufactured by Harima Chemicals Group, Inc.), and the like.

Commercially available amino resins include “AMIDIR (registered trademark) (former trade name: BECKAMINE)” (manufactured by DIC CORPORATION), “CYMEL (registered trademark)” (manufactured by Allnex Japan Inc.), “MELAN (registered trademark)” (manufactured by Showa Denko Materials Co., Ltd.), and the like.

Commercially available polylactic acid resins include “VYLOECOL (registered trademark) BE” (polylactic acid resin containing hydroxy groups, manufactured by TOYOBO CO., LTD.) and the like.

Commercially available oxazoline resins include “EPOCROS (registered trademark)” (manufactured by NIPPON SHOKUBAI CO., LTD.), “1,3-PBO” (manufactured by MIKUNI PHARMACEUTICAL INDUSTRIAL CO., LTD.) and the like.

Commercially available benzoxazine resins include “P-d,” “F-a” (manufactured by SHIKOKU CHEMICALS CORPORATION), and the like.

Commercially available silicone resins include “KR,” “KS” (manufactured by Shin-Etsu Chemical Co., Ltd.), “Silaplane (registered trademark)” (manufactured by JNC Corporation), “Gemlac (registered trademark)” (manufactured by KANEKA CORPORATION), and the like.

Commercially available fluorine resins include “LUMIFLON (registered trademark)” (manufactured by AGC Inc.), “FLUONATE (registered trademark)” (fluorine resin including hydroxy group, manufactured by DIC CORPORATION), and the like.

### 3.3. Light-Curable Resin

The resin of the present invention may be a light-curable resin.

The light-curable resin to be used is not limited as long as it has one or more functional groups in one molecule that can be used for crosslinking reactions upon being irradiated with light, for example, a (meth)acryloyl group, an epoxy group, a vinyl group, an oxetanyl group, and the like. Examples of the light-curable resin also include a low molecular weight compound such as the so-called “monomer” and oligomer.

Examples of the light-curable resin include acrylic (meth)acrylate, urethane (meth)acrylate, polyester (meth)acrylate, polyether (meth)acrylate, epoxy (meth)acrylate, polycarbonate (meth)acrylate, diepoxide resin, alicyclic epoxy resin, and the like.

Examples of commercially available acrylic (meth)acrylate include “8KX” (manufactured by TAISEI FINE CHEMICAL CO., LTD.) and the like.

Examples of commercially available urethane (meth)acrylate include “SHIKOH (registered trademark)” (manufactured by Mitsubishi Chemical Corporation), “BEAMSET (registered trademark) 500”(manufactured by Arakawa Chemical Industries, Ltd.), “LUXYDIR (registered trademark) (former trade name: UNIDIC) V-4000” (manufactured by DIC CORPORATION), “EBECRYL (registered trademark)” (manufactured by DAICEL-ALLNEX LTD.), “ART RESIN (registered trademark)” (manufactured by Negami Chemical Industrial Co., Ltd.), and the like.

Examples of commercially available polyester (meth)acrylate include “BEAMSET (registered trademark) 700”(manufactured by Arakawa Chemical Industries, Ltd.), “EBECRYL (registered trademark)” (manufactured by DAICEL-ALLNEX LTD.), and the like.

Examples of commercially available polyether (meth)acrylate include “EBECRYL (registered trademark) 80,” “81,” and “83” (manufactured by DAICEL-ALLNEX LTD.) and the like.

Examples of commercially available epoxy (meth)acrylate include “KAYARAD (registered trademark) ZAR” and “ZFR” (manufactured by Nippon Kayaku Co., Ltd.), “DICLITE (registered trademark)” (manufactured by DIC CORPORATION), “Ripoxy (registered trademark)” (manufactured by SHOWA DENKO K.K.), and the like.

Examples of commercially available polycarbonate (meth)acrylate include “PCD-DM,” “PCD-DA” (manufactured by UBE Corporation), and the like.

Examples of commercially available diepoxide resin include “UVACURE (registered trademark)” (manufactured by DAICEL-ALLNEX LTD.) and the like.

Examples of commercially available alicyclic epoxy resin include “CELLOXIDE (registered trademark) 2021P” (manufactured by DAICEL-ALLNEX LTD.) and the like.

### 3.4. Heat and Light-Curable Resin

The resin of the present invention may be a heat and light-curable resin.

The heat and light-curable resin to be used is not limited as long as it has a functional group(s) that can be used for crosslinking reactions upon being heated, in addition to the functional group(s) that can be used for crosslinking reactions upon being irradiated with light.

Examples of commercially available heat and light-curable resin include “CYCLOMER (registered trademark) P” (manufactured by Daicel Corporation), DICLITE (registered trademark)” (manufactured by DIC CORPORATION), “Ripoxy (registered trademark) PR” (manufactured by SHOWA DENKO K.K.), “KAYARAD (registered trademark) ZFR1122” (manufactured by Nippon Kayaku Co., Ltd.), and the like.

The functional groups that can be used for cross-linking reactions upon irradiation with light may also function as functional groups that can be used for cross-linking reactions upon heating. The above resins may be used alone or in combination of two or more types.

### 4. Other Additives

The flame-retardant resin composition of the present invention may contain other additives according to the purpose and to the extent that the effect of the invention is not affected.

Examples of additives include an antioxidant, a filler, a crystal nucleating agent, and the like. The content of the additive(s) relative to the total mass of the flame-retardant resin composition is preferably in the range of 0 to 30% by mass, and more preferably in the range of 0 to 20% by mass.

### Manufacturing Method of Flame-Retardant Resin Composition

The method of manufacturing the flame-retardant resin composition of the present invention is not particularly limited. When the resin is a thermoplastic resin, a melt kneading method is preferred, and any known melt kneading method can be used. When the resin is a resin other than a thermoplastic resin, a known method that allows each component to be mixed and homogenized can be used.

Hereinafter, the method of manufacturing the flame-retardant resin composition of the present invention using the melt kneading method will be described.

In the melt kneading method, for example, the acidic polysaccharide, the flame retardant, and the resin are pre-mixed using one of various mixers such as a tumbler or a high-speed mixer known as a Henschel mixer, and then melted and kneaded with a kneading device such as the Banbury (registered trademark) mixer, a roll, the plastograph (registered trademark), a single screw extruder, a twin screw extruder, a kneader, and the like.

Among these, an extruder is preferably used from the viewpoint of production efficiency, and the twin screw extruder is even more preferably used. After the materials are melted and kneaded using the extruder and then extruded into strands, the kneaded materials can be processed into pellets, flakes, or other forms.

Preferably, the materials are each dried sufficiently in advance before the pre-mixing. The temperature during drying is not particularly limited, but is preferably in the range of 60 to 120° C. The period of drying time is not particularly limited, but is preferably in the range of 2 to 6 hours. From the viewpoint of facilitating the drying process, the materials are preferably dried under reduced pressure. The materials may be dried as described above after the pre-mixing.

The temperature in melting and kneading is not particularly limited, but is preferably selected depending on the type of the resin used, etc., specifically, it is preferably in the range of 150 to 280° C. Here, the temperature in melting and kneading corresponds to the cylinder temperature in a kneading device such as the twin screw extruder, for example. When multiple temperature settings are made in the cylinder of the kneading device, the highest temperature in the cylinder portion is referred to as the cylinder temperature. The kneading pressure is not particularly limited, but is preferably in the range of 1 to 20 MPa.

The discharge rate from the kneading device is not particularly limited, but from the viewpoint of sufficient melting and kneading, it is preferably in the range of 10 to 100 kg/hr, and more preferably in the range of 20 to 70 kg/hr.

The kneaded material that has been melted and kneaded by the kneading device as described above is preferably cooled after being extruded from the kneading device. Examples of the cooling method are not limited, and include water cooling through immersion of the kneaded material in water in the range of 0 to 60° C., cooling with gas in the range of -40 to 60° C., and contacting the kneaded material with metal in the range of -40 to 60° C.

The state and shape of the flame-retardant resin composition of the present invention is not particularly limited and may be a solid in the form of powder, granules, tablets, pellets, flakes, fibers, and the like, or a liquid.

### Flame-Retardant Resin Molded Product

The flame-retardant resin molded product of the present invention is characterized by being formed using the flame-retardant resin composition described above.

When the flame-retardant resin molded product of the present invention is formed using the flame-retardant resin composition described above, the resin molded product can have flame retardancy. When phosphorus compounds are used as the flame retardants, in addition to flame retardancy, mechanical strength and excellent appearance can also be achieved.

When the resin is the thermoplastic resin, the flame-retardant resin molded product of the present invention is obtained by melting and molding the above-described flame-retardant resin composition in various molding machines. The molding method can be selected according to the form and application of the molded product. Examples of molding method include injection molding, extrusion molding, compression molding, blow molding, calendar molding, and inflation molding. The molded sheet in a sheet or film shape obtained by extrusion molding or calendar molding may be further subjected to secondary molding such as vacuum forming or pressure molding.

When the resin is a curable resin other than the thermoplastic resin, the molded product is obtained by curing the flame-retardant resin composition described above using a conventionally known method for curing.

Examples of the flame-retardant resin molded product are not particularly limited and include parts (such as electrical and electronic parts, electrical components, exterior parts, and interior parts) in the fields of home appliances and automobiles, various packaging materials, household goods, office supplies, plumbing, agricultural materials, and the like.

### Flame-Retardant Resin Housing and Electronic Device

The flame-retardant resin housing of the present invention is characterized in that it contains the flame-retardant resin molded product described above. The electronic device of the present invention is also characterized in that it includes the flame-retardant resin molded product described above.

In other words, the flame-retardant resin molded product described above may be used in an electronic device and the like, either as a housing that accommodates the electronic device or as a component.

In the present invention, the term “electronic device” refers to an electrical product based on electronics technology.

Although there is no particular limitation to the articles to be accommodated by the flame-retardant resin housing of the present invention, the electronic device and the like is preferably accommodated. The flame-retardant resin housing of the present invention can also be applied to other housings that are usually preferably manufactured with a flame-retardant resin.

When a phosphorus compound is used as the flame retardant, the resulting flame-retardant resin housing has the excellent mechanical strength and appearance in addition to flame retardancy.

The electronic device is not particularly limited. Examples of the electronic device include a computer, a scanner, a copier, a printer, a facsimile machine, office automation equipment such as multi-function peripherals (MFPs) that combine these functions, and a digital printing system for commercial printing.

The figure shows a specific example of the electronic device of the present invention. The figure is a schematic oblique view of a large photocopier 10 using the flame-retardant resin molded product of the present invention as an exterior part. As shown in the figure, the large photocopier 10 has parts G1 to G9 as an outer covering. The flame-retardant resin molded product of the present invention can be used for such exterior parts G1 to G9.

### EXAMPLES

The present invention will be specifically described below with examples, but is not limited thereto. In the examples, “part” or “%” denotes “part by mass” or “% by mass” unless otherwise noted.

In the following examples, operations were performed at room temperature (25° C.) unless otherwise noted.

### Preparation of Resin Composition

The following resins, polysaccharides, and flame retardants were used as constituents of the resin composition in the examples.

### Resin

The following commercially available resins were used. The softening point of the mixed resin was 200° C. or higher, and the softening points of the other resins were 200° C. or lower.

### 1. Polystyrene-Based Resins

Polystyrene resin (PS): “H9152” (product name, manufactured by PS Japan Corporation)

Acrylonitrile-butadiene-styrene copolymer (ABS): “TOYOLAC (registered trademark) 700-314” (product name, manufactured by TORAY INDUSTRIES, INC.)

### 2. Other Thermoplastic Resins

Polylactic acid resin (PLA): “TERRAMAC (registered trademark) TE-8303” (product name, manufactured by UNITIKA LTD.).

Mixed resin (PC/AB S): “Multilon (registered trademark) T-3750” (product name, manufactured by TEIJIN LIMITED.)

### Polysaccharides

The following polysaccharides that are commercially available or obtained in the synthetic examples were used. Polysaccharides A1 to A12 are the acidic polysaccharides preferably used in the present invention.

A1: Calcium alginate: “CAW-80” (product name, manufactured by KIMICA Corporation)
A2: Carrageenan: “GENUGEL (registered trademark) carrageenan type WG-108” (product name, manufactured by Sansho Co., Ltd.)
A3: Xanthan gum: “Xanthan gum” (product name, manufactured by Tokyo Chemical Industry Co., Ltd.)
A4: Sodium alginate: “KIMICA Alginate I-3G” (product name, manufactured by KIMICA Corporation)
A5: Carboxymethyl cellulose: Aqualon (registered trademark) CMC-7LF (product name, manufactured by Ashland Inc.)
A10: Pectin: “Pectin, from citrus” (product name, manufactured by FUJIFILM Wako Pure Chemical Corporation)
A11: Gellan gum: “Gellan gum” (product name, manufactured by FUJIFILM Wako Pure Chemical Corporation)
C1: Cellulose: “Cellulose, Powder, through 38 µm (400 mesh)” (product name, manufactured by FUJIFILM Wako Pure Chemical Corporation)

### A6: Synthesis of Carboxymethyl Cellulose

The following ingredients were put in a 5 L flask and stirred at room temperature.

| | |
|---|---|
| Isopropyl alcohol | 2,500 mass parts |
| Water | 180 parts by mass |

Powdered cellulose (Cellulose, Powder, through 38 µm (400 mesh) manufactured by FUJIFILM Wako

| | |
|---|---|
| Pure Chemical Corporation, Polysaccharide C1) | 100 parts by mass |

A solution of the following components was added to the flask and stirred at 35° C. for 1 hour.

| | |
|---|---|
| Sodium hydroxide | 21.6 parts by mass |
| Water | 25 parts by mass |

Then, a mixture solution of the following components was added dropwise to this flask and stirred at 65° C. for 2 hours to be reacted.

| | |
|---|---|
| Monochloroacetic acid | 11.6 parts by mass |
| Isopropyl alcohol | 15 parts by mass |

The resulting reaction solution was cooled to room temperature, taken out, and stirred with the following components to neutralize excess sodium hydroxide.

The following components were then added, stirred, and the slurry was filtered. The filter residue was washed with acetone and dried. As a result, 103 parts by mass of carboxymethyl cellulose as Polysaccharide A6 was obtained.

| | |
|---|---|
| Aqueous methanol solution of 70% by mass | 3,000 parts by mass |

The number of acidic functional groups of the resulting Polysaccharide A6 was 0.20, as confirmed by the method of measuring the substitution degree of carboxymethyl groups described above.

### A7: Synthesis of Carboxymethyl Cellulose

The following ingredients were put in a 5 L flask and stirred at room temperature.

| | |
|---|---|
| Isopropyl alcohol | 2,500 mass parts |
| Water | 180 parts by mass |

Powdered cellulose (Cellulose, Powder, through 38 µm (400 mesh) manufactured by FUJIFILM Wako

| | |
|---|---|
| Pure Chemical Corporation, Polysaccharide C1) | 100 parts by mass |

A solution of the following components was added to the flask and stirred at 35° C. for 1 hour.

| | |
|---|---|
| Sodium hydroxide | 56.1 parts by mass |
| Water | 60 parts by mass |

Then, a mixture solution of the following components was added dropwise to this flask and stirred at 65° C. for 2 hours to be reacted.

| | |
|---|---|
| Monochloroacetic acid | 63.4 parts by mass |
| Isopropyl alcohol | 45 parts by mass |

The resulting reaction solution was cooled to room temperature, taken out, and stirred with the following components to neutralize excess sodium hydroxide.

| | |
|---|---|
| Aqueous methanol solution of 70% by mass | 1,000 parts by mass |
| Acetic acid | 3.7 parts by mass |

The following components were then added, stirred, and the slurry was filtered. The filter residue was washed with acetone and dried. As a result, 123 parts by mass of carboxymethyl cellulose as Polysaccharide A7 was obtained.

| | |
|---|---|
| Aqueous methanol solution of 70% by mass | 3,000 parts by mass |

The number of acidic functional groups of the resulting Polysaccharide A7 was 0.61, as confirmed by the method of measuring the substitution degree of carboxymethyl groups described above.

### A8: Synthesis of Carboxymethyl Cellulose

The following ingredients were put in a 5 L flask and stirred at room temperature.

| | |
|---|---|
| Isopropyl alcohol | 2,500 mass parts |
| Water | 180 parts by mass |

Powdered cellulose (Cellulose, Powder, through 38 µm (400 mesh) manufactured by FUJIFILM Wako Pure Chemical Corporation, Polysaccharide C1) 100 parts by mass

A solution of the following components was added to the flask and stirred at 35° C. for 1 hour.

| | |
|---|---|
| Sodium hydroxide | 160 parts by mass |
| Water | 150 parts by mass |

Then, a mixture solution of the following components was added dropwise to this flask and stirred at 65° C. for 2 hours to be reacted.

| | |
|---|---|
| Monochloroacetic acid | 180 parts by mass |
| Isopropyl alcohol | 130 parts by mass |

The resulting reaction solution was cooled to room temperature, taken out, and stirred with the following components to neutralize excess sodium hydroxide.

| | |
|---|---|
| Aqueous methanol solution of 70% by mass | 1,000 parts by mass |
| Acetic acid | 8.2 parts by mass |

The following components were then added, stirred, and the slurry was filtered. The filter residue was washed with acetone and dried. As a result, 152 parts by mass of carboxymethyl cellulose as Polysaccharide A8 was obtained.

| | |
|---|---|
| Aqueous methanol solution of 70% by mass | 3,000 parts by mass |

The number of acidic functional groups of the resulting Polysaccharide A8 was 1.70, as confirmed by the method of measuring the substitution degree of carboxymethyl groups described above.

### A9: Preparation of Magnesium Alginate

Sodium alginate (Polysaccharide A4) was dissolved in water, and an aqueous alginate sodium solution of 10% by mass was prepared. An aqueous magnesium chloride solution of 10% by mass was dropped into the solution and filtered. The precipitated magnesium alginate as filtrate was dried.

### A12: Preparation of Calcium Alginate and Cellulose Mixture

Calcium alginate (Polysaccharide A1) and cellulose (Polysaccharide C1) were mixed in a 3:1 molar ratio when converted to monosaccharides.

The number of acidic functional groups of the obtained Polysaccharide A12 was confirmed to be 0.75.

### Flame Retardant

The following commercially available flame retardants were used.
Aromatic condensed phosphate ester (condensed phosphate ester): “PX-200” (product name, manufactured by DAIHACHI CHEMICAL INDUSTRY CO., LTD.)
Triphenyl phosphate (phosphate ester): “TPP” (product name, manufactured by DAIHACHI CHEMICAL INDUSTRY CO., LTD.)
Ammonium polyphosphate: “TAIEN K” (product name, manufactured by Taihei Chemical Industrial Co., Ltd.)

The components of each resin composition are shown in TABLE I. The symbol “-” in TABLE I indicates that the flame retardant is not contained.

TABLE I

| Resin composition No. | Resin | | Polysaccharide | | | |
|---|---|---|---|---|---|---|
| | Type | Content [% by mass] | | Type | Number of acidic functional groups | Content :[% by mass] |
| 1 | PS | 65 | A1 | Calcium alginate | 1.00 | 25 |
| 2 | PS | 65 | A2 | Carrageenan | 0.50 | 25 |
| 3 | PS | 65 | A3 | Xanthan gum | 0.40 | 25 |
| 4 | PS | 65 | A4 | Sodium alginate | 1.00 | 25 |
| 5 | PS | 65 | A6 | Carboxymethyl cellulose | 0.20 | 25 |
| 6 | PS | 65 | A7 | Carboxymethyl cellulose | 0.61 | 25 |
| 7 | PS | 65 | A5 | Carboxymethyl cellulose | 1.40 | 25 |
| 8 | PS | 65 | A8 | Carboxymethyl cellulose | 1.70 | 25 |
| 9 | PS | 85 | A1 | Calcium alginate | 1.00 | 5 |
| 10 | PS | 75 | A1 | Calcium alginate | 1.00 | 15 |
| 11 | PS | 55 | A1 | Calcium alginate | 1.00 | 35 |
| 12 | PS | 50 | A1 | Calcium alginate | 1.00 | 40 |
| 13 | PS | 74 | Α1 | Calcium alginate | 1.00 | 25 |
| 14 | PS | 70 | A1 | Calcium alginate | 1.00 | 25 |
| 15 | PS | 60 | A1 | Calcium alginate | 1.00 | 25 |
| 16 | PS | 55 | A1 | Calcium alginate | 1.00 | 25 |
| 17 | ABS | 65 | A1 | Calcium alginate | 1.00 | 25 |
| 18 | PLA | 65 | A1 | Calcium alginate | 1.00 | 25 |
| 19 | PS | 87 | A1 | Calcium alginate | 1.00 | 3 |
| 20 | PS | 40 | A1 | Calcium alginate | 1.00 | 50 |
| 21 | PS | 74.5 | A1 | Calcium alginate | 1.00 | 25 |
| 22 | PS | 50 | A1 | Calcium alginate | 1.00 | 25 |
| 23 | PS | 65 | A9 | Magnesium alginate | 1.00 | 25 |
| 24 | PS | 65 | A10 | Pectin | 0.40 | 25 |
| 25 | PS | 65 | Α11 | Gellan gum | 0.25 | 25 |
| 26 | PS | 65 | A1 | Calcium alginate | 1.00 | 25 |
| 27 | PS | 65 | A1 | Calcium alginate | 1.00 | 25 |
| 28 | PC/ABS | 65 | A1 | Calcium alginate | 1.00 | 25 |
| 29 | PS | 65 | A1 | Calcium alginate Cellulose | 0.75 | 25 |
| 100 | PS | 65 | A1 | Calcium alginate | 1.00 | 25 |
| 101 | PS | 65 | C1 | Cellulose | 0.00 | 25 |

TABLE I Continued

| Resin composition No. | Flame-retardant | | Temperature in molding |
|---|---|---|---|
| | Type | [% by mass] | |
| 1 | Condensed phosphate ester | 10 | 200 |
| 2 | Condensed phosphate ester | 10 | 200 |
| 3 | Condensed phosphate ester | 10 | 200 |
| 4 | Condensed phosphate ester | 10 | 200 |
| 5 | Condensed phosphate ester | 10 | 200 |
| 6 | Condensed phosphate ester | 10 | 200 |
| 7 | Condensed phosphate ester | 10 | 200 |
| 8 | Condensed phosphate ester | 10 | 200 |
| 9 | Condensed phosphate ester | 10 | 200 |
| 10 | Condensed phosphate ester | 10 | 200 |
| 11 | Condensed phosphate ester | 10 | 200 |
| 12 | Condensed phosphate ester | 10 | 200 |
| 13 | Condensed phosphate ester | 1 | 200 |
| 14 | Condensed phosphate ester | 5 | 200 |
| 15 | Condensed phosphate ester | 15 | 200 |
| 16 | Condensed phosphate ester | 20 | 200 |
| 17 | Condensed phosphate ester | 10 | 200 |
| 18 | Condensed phosphate ester | 10 | 200 |
| 19 | Condensed phosphate ester | 10 | 200 |
| 20 | Condensed phosphate ester | 10 | 200 |
| 21 | Condensed phosphate ester | 0.5 | 200 |
| 22 | Condensed phosphate ester | 25 | 200 |
| 23 | Condensed phosphate ester | 10 | 200 |
| 24 | Condensed phosphate ester | 10 | 200 |
| 25 | Condensed phosphate ester | 10 | 200 |
| 26 | Phosphate ester | 10 | 200 |
| 27 | Ammonium polyphosphate | 10 | 200 |
| 28 | Condensed phosphate ester | 10 | 240 |
| 29 | Condensed phosphate ester | 10 | 200 |
| 100 | - | 0 | 200 |
| 101 | Condensed phosphate ester | 10 | 200 |

### Preparation of Resin Composition

The resin and polysaccharide were each pre-dried at 80° C. for 4 hours prior to kneading. Then, the resin and the polysaccharide were weighed and dry-blended in the respective component concentrations (in % by mass) shown in TABLE I. The dry-blended mixture was then fed into a cylinder of a twin screw extruder “KTX-30” (manufactured by KOBE STEEL. LTD.) at a rate of 10 kg per hour from the raw material feed port (hopper) to be melted and kneaded under the conditions of a cylinder temperature of 200° C. (exceptionally 240° C. for Resin Composition 28) and a screw speed of 200 rpm. The melted resin that had been kneaded was cooled in a water bath at 30° C. and pelletized in a pelletizer. The resin composition was thus obtained.

### Evaluation

### Evaluation 1: Appearance

The obtained pellets of each resin composition were dried in a hot-air circulating dryer at 80° C. for 5 hours. Then, the dried pellets of each resin composition were molded into an imitation of the exterior part G8 of the large photocopier shown in the figure at a cylinder temperature of 200° C. (exceptionally 240° C. for Resin Composition 28) and a mold temperature of 80° C. using an injection molding machine “J1300E-C5” (manufactured by The Japan Steel Works, LTD.), and a sample was taken from the center portion. The obtained sample was visually observed for appearance and was evaluated according to the following criteria.
AA: There is no defect in appearance.
BB: There is some unevenness in color, but the resin composition can be used for exterior parts.
CC: There is unevenness in color, but the resin composition can be used for interior parts or parts that do not stand out.
DD: The resin composition has a lot of unevenness in color and cannot be used.
The resin compositions evaluated as AA to CC are acceptable because there is no problem in practical use.

### Evaluation 2: Flame Retardancy

The obtained pellets of each resin composition were dried at 80° C. for 4 hours. Then, the dried pellets of each resin composition were molded into a strip-shaped test piece having a length of 125 mm, a width of 13 mm, and a thickness of 1.6 mm at a cylinder temperature of 200° C. (exceptionally 240° C. for Resin Composition 28) and a mold temperature of 50° C. using an injection molding machine “J55EL II” (manufactured by The Japan Steel Works, LTD.).

The test piece was then humidified for 48 hours in a thermostatic chamber at a temperature of 23° C. and humidity of 50%, and subjected to a flame retardancy test in accordance with the UL94 test (Test for Flammability of Plastic Materials for Parts in Devices and Appliances) defined by Underwriters Laboratories Inc. (UL). The test piece was subjected to the UL94V test (20 mm Vertical Burning Test) that provide the ratings regarding flame retardancy and was evaluated according to the following criteria.
AA: The resin composition is classified as V-0
BB: The resin composition is classified as V-1
CC: The resin composition is classified as V-2
DD: The resin composition is out of the defined criteria
The resin compositions evaluated as AA to CC meet the criteria of UL94HB and are acceptable because there is no problem in practical use.

### Evaluation 3: Mechanical Strength

The obtained pellets of each resin composition were dried at 80° C. for 4 hours. Then, the dried pellets of each resin composition were molded into a strip-type test piece having a length of 80 mm, a width of 10 mm, and a thickness of 4.0 mm at a cylinder temperature of 200° C. (exceptionally 240° C. for Resin Composition 28) and a mold temperature of 50° C. using an injection molding machine “J55EL II” (manufactured by The Japan Steel Works, LTD.).

After 300 waste shots, injection molding of 100 consecutive shots was performed. The variation of flexural strength, XTS (%), of the obtained 100 test pieces was determined from the following formula and evaluated based on the following criteria.

$$\text{XTS} \left(\%\right) = \frac{\left(T {R}_{m a x} - T {R}_{m i n}\right)}{T {R}_{a v}} \times 100$$

In the above formula, TRₘₐₓ represents the maximum flexural strength (MPa) of the 100 test pieces. TRₘᵢₙ represents the minimum flexural strength of the 100 test pieces. TRₐᵥ represents the average flexural strength of the 100 test pieces. The flexural strength of the test pieces was measured in accordance with JIS-K7171.

AA: TRₐᵥ is 20 MPa or more, and XTS is less than 0.5%.
BB: TRav is 20 MPa or more, and XTS is 0.5% or more and less than 5%.
CC: TRav is 20 MPa or more, and XTS is 5% or more and less than 15%.
DD: TRₐᵥ is less than 20 MPa, and XTS is 15% or more.

The evaluation results are shown in TABLE II.

TABLE 11

| Resin composition No. | Evaluation | | | Remarks |
|---|---|---|---|---|
| | Appearance | Flame retardancy | Mechanical strength | |
| 1 | AA | BB | AA | Present invention |
| 2 | BB | CC | BB | Present invention |
| 3 | BB | CC | BB | Present invention |
| 4 | BB | BB | BB | Present invention |
| 5 | AA | CC | BB | Present invention |
| 6 | BB | BB | BB | Present invention |
| 7 | BB | BB | CC | Present invention |
| 8 | CC | BB | CC | Present invention |
| 9 | AA | BB | AA | Present invention |
| 10 | AA | BB | AA | Present invention |
| 11 | BB | AA | BB | Present invention |
| 12 | BB | AA | BB | Present invention |
| 13 | AA | BB | AA | Present invention |
| 14 | BB | BB | AA | Present invention |
| 15 | BB | AA | BB | Present invention |
| 16 | BB | AA | BB | Present invention |
| 17 | AA | BB | AA | Present invention |
| 18 | AA | BB | AA | Present invention |
| 19 | AA | CC | AA | Present invention |
| 20 | CC | AA | CC | Present invention |
| 21 | BB | CC | AA | Present invention |
| 22 | BB | AA | CC | Present invention |
| 23 | AA | BB | BB | Present invention |
| 24 | CC | CC | BB | Present invention |
| 25 | CC | CC | BB | Present invention |
| 26 | AA | BB | AA | Present invention |
| 27 | AA | CC | AA | Present invention |
| 28 | CC | BB | CC | Present invention |
| 29 | BB | BB | AA | Present invention |
| 100 | BB | CC | AA | Reference example |
| 101 | BB | DD | AA | Comparative example |

The evaluation results reveal that the resin composition of the present invention has the excellent flame retardancy due to the inclusion of the acidic polysaccharide and the flame retardant.

The reference example (Resin Composition 100) containing only the acidic polysaccharide also has sufficient flame retardancy for practical use. However, the Resin Compositions 1 and 26 containing the further flame retardant have excellent appearance in addition to flame retardancy.

Comparison of Resin Compositions 1 to 8 and 101 reveals that the resin compositions of the present invention have excellent flame retardancy due to the inclusion of the acidic polysaccharide.

Comparison of Resin Compositions 1 to 3, 5 to 8, 24, 25, 29, and 101, and particularly comparison of Resin Compositions 5 to 8, reveals that the number of acidic functional groups in the acidic polysaccharide of the present invention in the range of 0.20 to 1.50, and more preferably in the range of 0.60 to 1.20, results in the excellent flame retardancy.

Comparison of resin compositions 1, 4, and 23 reveals that the resin compositions of the present invention have excellent mechanical strength and appearance as well as flame retardancy due to the inclusion of a salt formed with an ion having two or more valences in the acidic polysaccharide. The resin composition has the excellent mechanical strength and appearance when the acidic polysaccharide is an alginate, in particular, calcium alginate.

Comparison of Resin Compositions 1, 9 to 12, 19, and 20 reveals that the resin compositions of the present invention have the excellent mechanical strength and appearance in addition to the flame retardancy due to the inclusion of the acidic polysaccharide in the range of 5 to 40% by mass.

Comparison of Resin Compositions 1, 13, 16, 21, and 22 reveals that the resin compositions of the present invention have the excellent mechanical strength and appearance in addition to the flame retardancy due to the inclusion of the flame retardant within the range of 1 to 20% by mass.

Comparison of Resin Compositions 1, 26, and 27 reveals that the resin compositions of the present invention have excellent flame retardancy when the flame retardant is a phosphorous compound, in particular, a phosphate ester. Comparison of Resin Compositions 1 and 28 reveals that the resin compositions of the present invention have excellent mechanical strength and appearance as well as flame retardancy due to the softening point of the thermoplastic resin being 200° C. or less.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2022-023403, filed on Feb. 18, 2022, including description, claims, drawings and abstract is incorporated herein by reference in its entirety.

1. A flame-retardant resin composition comprising:
an acidic polysaccharide; and
a flame retardant.

2. The flame-retardant resin composition according to claim 1, wherein the flame retardant is a phosphorus compound.

3. The flame-retardant resin composition according to claim 1, wherein the acidic polysaccharide includes at least one of a polysaccharide having an acidic functional group, a derivative of the polysaccharide having the acidic functional group and having a modified moiety that is not in the acidic functional group, a salt of the polysaccharide having the acidic functional group, and a salt of the derivative.

4. The flame-retardant resin composition according to claim 3, wherein a total number of the acidic functional group per monosaccharide unit in the acidic polysaccharide is in the range of 0.20 to 1.50, the acidic functional group being optionally neutralized.

5. The flame-retardant resin composition according to claim 3, wherein the acidic polysaccharide includes the salt that is formed with an ion having two or more valences.

6. The flame-retardant resin composition according to claim 3, wherein a total number of the acidic functional group per monosaccharide unit in the acidic polysaccharide is in the range of 0.60 to 1.20, the acidic functional group being optionally neutralized.

7. The flame-retardant resin composition according to claim 1, wherein a content of the acidic polysaccharide is in the range of 5 to 40% by mass relative to a total mass of the flame-retardant resin composition.

8. The flame-retardant resin composition according to claim 1, wherein a content of the flame retardant is in the range of 1 to 20% by mass relative to a total mass of the flame-retardant resin composition.

9. The flame-retardant resin composition according to claim 3, wherein the acidic functional group is a carboxy group or a sulfo group.

10. The flame-retardant resin composition according to claim 1, wherein the acidic polysaccharide includes at least one of alginic acid, a salt of alginic acid, carrageenan, pectin, xanthan gum, and gellan gum.

11. The flame-retardant resin composition according to claim 10, wherein the acidic polysaccharide includes calcium alginate as the salt of alginic acid.

12. The flame-retardant resin composition according to claim 2, wherein the phosphorus compound is aphosphate ester.

13. The flame-retardant resin composition according to claim 1, further comprising:
a thermoplastic resin.

14. The flame-retardant resin composition according to claim 13, wherein a softening point of the thermoplastic resin is 200° C. or lower.

15. The flame-retardant resin composition according to claim 13, wherein the thermoplastic resin is a polystyrene-based resin.

16. A flame-retardant resin molded product that is formed of the flame-retardant resin composition according to claim 1.

17. A flame-retardant resin housing including the flame-retardant resin molded product according to claim 16.

18. An electronic device including the flame-retardant resin molded product according to claim 16.
